(19) United States
(12) Patent Application Publication
(10) Pub. No.: US 2007/0121814 A1
(43) Pub. Date: May 31, 2007

(54) Speech recognition based computer telephony system

(75) Inventors: Alan L. Creighton, Birmingham, AL (US); Hilaire Bruno Desa, Pelham, AL (US); Robert Lloyd Hancock, Gardendale, AL (US); Jennifer Brown Jacobs, Maylene, AL (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: mypeople, L.L.C., Birmingham, AL (US)

(21) Appl. No.: 11/289,435

(22) Filed: Nov. 30, 2005

(51) Int. Cl. H04M 1/64

(52) U.S. Cl. 379/88.01

(57) ABSTRACT

A computer telephony system interfaces with a user of a telephone by detecting an off-hook at the telephone. The system then automatically couples the telephone to a speech recognition system and then receives an input from the user to the speech recognition system. The input instructs the system to dial a telephone number or requests some other telecommunication service.

### FIELD OF THE INVENTION

One embodiment of the present invention is directed to computer telephony, and more particularly to a system integrating a speech recognition system with a computer telephony system to provide communication services.

### BACKGROUND INFORMATION

Voice over Internet protocol (“VoIP”) telephone services and related systems are known. Such systems allow voice calls using Internet Protocol (“IP”) networks such as the Internet as an alternative to traditional public switched telephone networks (“PSTN”). Unlike the PSTN, which is circuit-switched, the Internet is packet-switched. As such, communications on the Internet is accomplished by transmitting and receiving packets of data. In addition to data, each packet contains a destination address to ensure that it is routed correctly. The format of these packets is defined by the IP.

One type of allowable data is encoded, digitized voice, termed VoIP. VoIP is voice that is packetized as defined by the Internet protocol, and communicated over the Internet for telephone-like communication. Individual VoIP packets may travel over different network paths to reach a final destination where the packets are reassembled in correct sequence to reconstruct the voice information.

Meanwhile, speech recognition technology is used more and more for telephone applications like travel booking and information, financial account information, customer service call routing, and directory assistance. Using constrained grammar recognition, such applications can achieve remarkably high accuracy. Research and development in speech recognition technology has continued to grow as the cost for implementing such voice-activated systems has dropped and the usefulness and efficacy of these systems has improved. For example, recognition systems optimized for telephone applications can often supply information about the confidence of a particular recognition, and if the confidence is low, it can trigger the application to prompt callers to confirm or repeat their request (for example “I heard you say ‘billing’, is that right?”). Further, speech recognition has enabled the automation of certain applications that are not automatable using push-button interactive voice response (“IVR”) systems, like directory assistance and systems that allow callers to “dial” by speaking names listed in an electronic phone book. Nevertheless, speech recognition based systems remain the exception because push-button systems are still much cheaper to implement and operate.

Most existing VoIP services offered to consumers and small businesses accomplish a basic task of facilitating telephone calls. Other desired services, such as information acquisition or advanced telecommunication services, are either not offered or are difficult to obtain by the user.

Based on the foregoing, there is a need for a system and method of implementing a VoIP system that provides additional features besides basic telephony in an easy to use manner.

### SUMMARY OF THE INVENTION

One embodiment of the present invention is a computer telephony system that interfaces with a user of a telephone by detecting an off-hook at the telephone. The system then automatically couples the telephone to a speech recognition system and then receives an input from the user to the speech recognition system. The input instructs the system to dial a telephone number or requests some other telecommunication service.

### BRIEF DESCRIPTION OF THE DRAWINGS

FIG. 1 is a block diagram of a communication system that can implement an embodiment of the present invention.

FIG. 2 is a block diagram of a network operations center that is coupled to the Internet.

FIG. 3 is a block diagram of the network operations center in accordance with one embodiment of the present invention and illustrating some of the modules of functionality that is provided to a user of a telephone.

FIG. 4 is a flow diagram of the functionality performed by the network operations center when an outbound call is made by a user at the telephone, or when a user requests other communication services.

FIG. 5 illustrates a graphical user interface in accordance with one embodiment of the present invention.

FIG. 6 illustrates another graphical user interface in accordance with one embodiment of the present invention.

FIG. 7 illustrates another graphical user interface in accordance with one embodiment of the present invention.

FIG. 8 illustrates another graphical user interface in accordance with one embodiment of the present invention.

FIG. 9 illustrates another graphical user interface in accordance with one embodiment of the present invention.

FIG. 10 illustrates another graphical user interface in accordance with one embodiment of the present invention.

FIG. 11 illustrates another graphical user interface in accordance with one embodiment of the present invention.

FIG. 12 illustrates another graphical user interface in accordance with one embodiment of the present invention.

FIG. 13 illustrates another graphical user interface in accordance with one embodiment of the present invention.

FIG. 14 illustrates another graphical user interface in accordance with one embodiment of the present invention.

### DETAILED DESCRIPTION

One embodiment of the present invention is a speech recognition based computer telephony system in which a user is automatically routed to a speech recognition system upon initiation of a telephone call. The user can then obtain a wide variety of communication services through the speech recognition system.

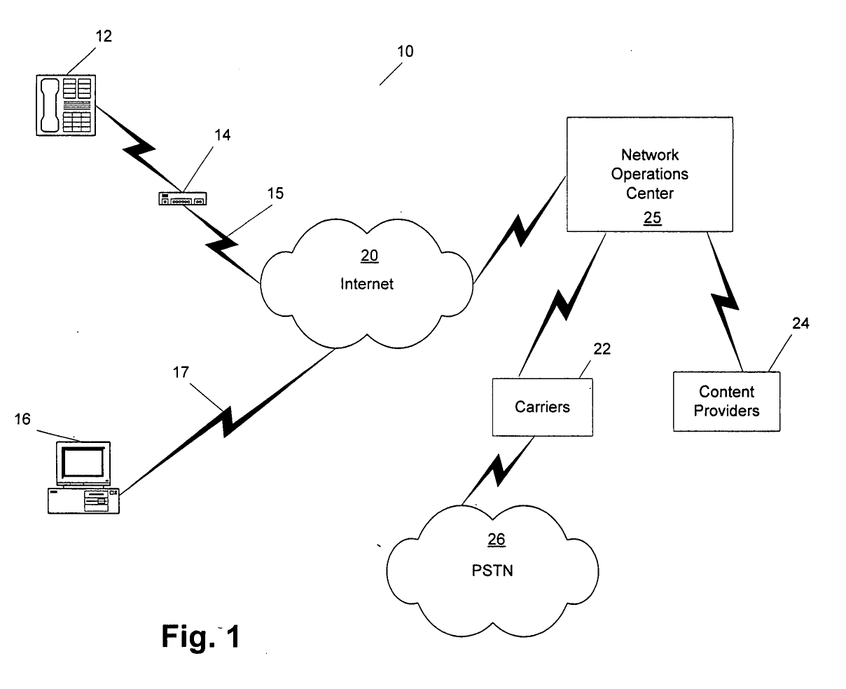

FIG. 1 is a block diagram of a communication system 10 that can implement an embodiment of the present invention.

A user interacts with communication system 10 through either a telephone 12 or a computer 16. Telephone 12 can be any plain old telephone system (“POTS”). In one embodiment, telephone 12 is coupled to an analog telephone adapter (“ATA”) 14, which functions as a handset-to-Ethernet adaptor that turns traditional telephone devices into IP devices. ATA 14 allows telephone 12 to be coupled to the Internet 20 over a broadband IP connection 15. In one embodiment, ATA 14 is the SPA-3000 Analog Telephone Adapter from Sipura Technology Inc.

Computer 16 can be any general purpose computer or any other type of device that executes a browser and that connects to the Internet 20 through a link 17. A user of system 10 interfaces with computer 16 in order to set up functionality of the system, as discussed below. Computer 16 can be also used as a telephone 12 to provide telecommunication services.

A user at telephone 12 or computer 16 is ultimately coupled to a network operations center 25 through the Internet 20. As discussed below, the user at telephone 12 is automatically coupled to a speech recognizer in network operations center 25 as soon as telephone 12 goes “off-hook”.

Embodiments of the present invention are not limited to accessing network operations center 25 through only a POTS or computer. For example, network operations center 25 may also be accessed through a POTS over the PSTN 26 by dialing a number associated with network operations center 25, via a cellular telephone, or by any other known method.

Network operations center 25 is coupled to various telephone carriers 22 for coupling telephone 12 to another POTS over the PSTN. Further, network operations center 25 is coupled to one or more content providers 24 for providing content to a user at telephone 12. The content may be stored locally to content providers 24, or may be accessed from the Internet 20 of from some other source.

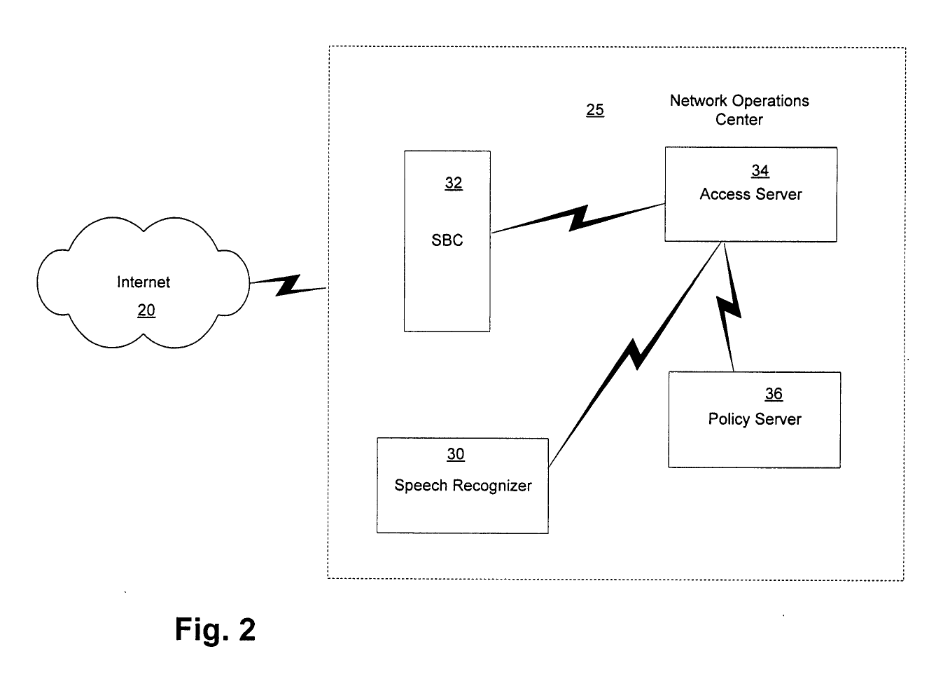

FIG. 2 is a block diagram of network operations center 25 that is coupled to Internet 20. Network operations center 25 includes a sessions border controller (“SBC”) 32. SBC 32 controls real-time interactive communications—voice, video, and multimedia sessions—across IP network borders. It provides new session controls in the areas of security, service reach and interworking, SLA assurance, revenue/profit assurance, and regulatory compliance.

Coupled to SBC 32 is an access server 34. Access server 34 includes a media gateway that converts traditional phone circuits such as PRIs or T-1s, enabling VoIP networks to connect to traditional phone networks. Access server 34 further implements customer features such as Caller ID, Call Waiting, and Speed Dialing. In one embodiment, access server 34 is the GSX and ASX controller from Sonus Corp.

Coupled to access server 34 is a policy server 36. Policy server 36 makes logical decisions determining which of the carriers 22 to route each call. These decisions can be based on cost, priority, or a combination of the two. In one embodiment, policy server 36 is the PSX controller from Sonus Corp.

Network operations center 25 further includes a speech recognizer 30 which is a speech recognition system that recognizes spoken words and further performs text-to-speech generation, and includes a navigational menu. In one embodiment, speech recognizer 30 is a speech recognition system from Nuance Communications, Inc.

In one embodiment of the present invention, when a user takes telephone 12 off-hook, the user is automatically routed to the speech recognizer 30 of network operations center 25. The user will be routed to network operations center 25 without any interaction by the user, such as a spoken word or Dual Tone Multi-Frequency (“DTMF”) input. Further, unlike known telephony systems where a user, upon taking a telephone off-hook, will hear a traditional audio “dial-tone”, in embodiments of the present invention, the user, upon taking telephone 12 off-hook, will instead hear a musical selection generated by the navigational menu of speech recognizer 12, and then a menu describing the telecommunication services available to the user. The services can be then selected by the user through spoken word or DTMF selection.

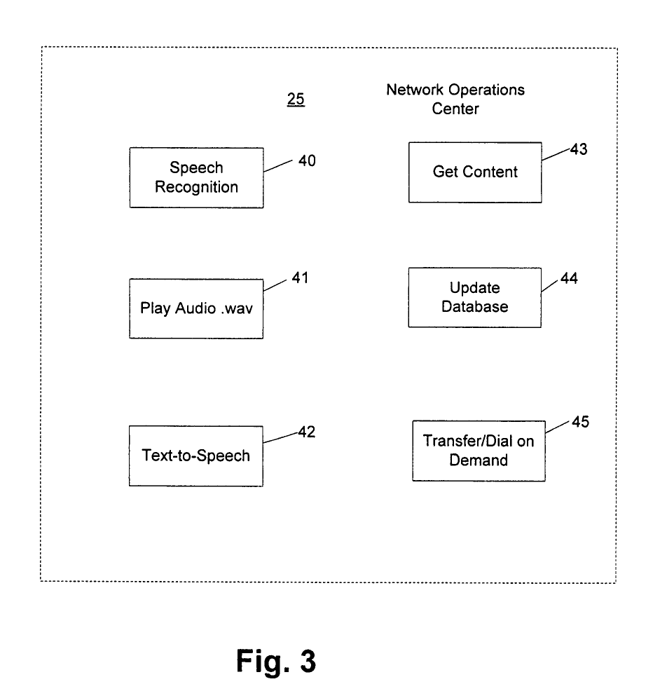

FIG. 3 is a block diagram of network operations center 25 in accordance with one embodiment of the present invention and illustrating some of the modules of functionality that is provided to a user of telephone 12. In one embodiment, the functionality is implemented by software stored in a memory and executed by a processor. In one embodiment, the software functionality is implemented using a Voice Extensible Markup Language (“VXML”) interpreter. In other embodiments, the functionality can be performed by hardware, or any combination of hardware and software.

Speech recognition module 40 allows the user to interact with network operations center 25 by listening to audio that is either pre-recorded or computer-synthesized and submitting audio input through the user's natural speaking voice or through a keypad on telephone 12.

Play audio module 41 plays the audio to the user at telephone 12 when the telephone goes off-hook. The audio may be in the form of a .wav file and may be musical. As disclosed, the audio takes the place of a traditional dial tone that a user of a telephone will initially hear in prior art telephony systems.

Text-to-speech module 42 performs a form of speech synthesis that converts text into spoken voice output that can be heard by a user of telephone 12. In one embodiment, the text is content such as weather, horoscope, etc. that is requested by the user.

Get content module 43 retrieves content that is requested by the user through speech recognition module 40. The content could be retrieved from local cache storage or retrieved real time from the Internet 20 or other source.

Update database module 44 allows a user at computer 16, through web pages, to update personal selections for that user's profile.

Transfer/dial-on-demand module 45 will couple the user at telephone 12 to another telephone over the PSTN or other network based on a request from the user.

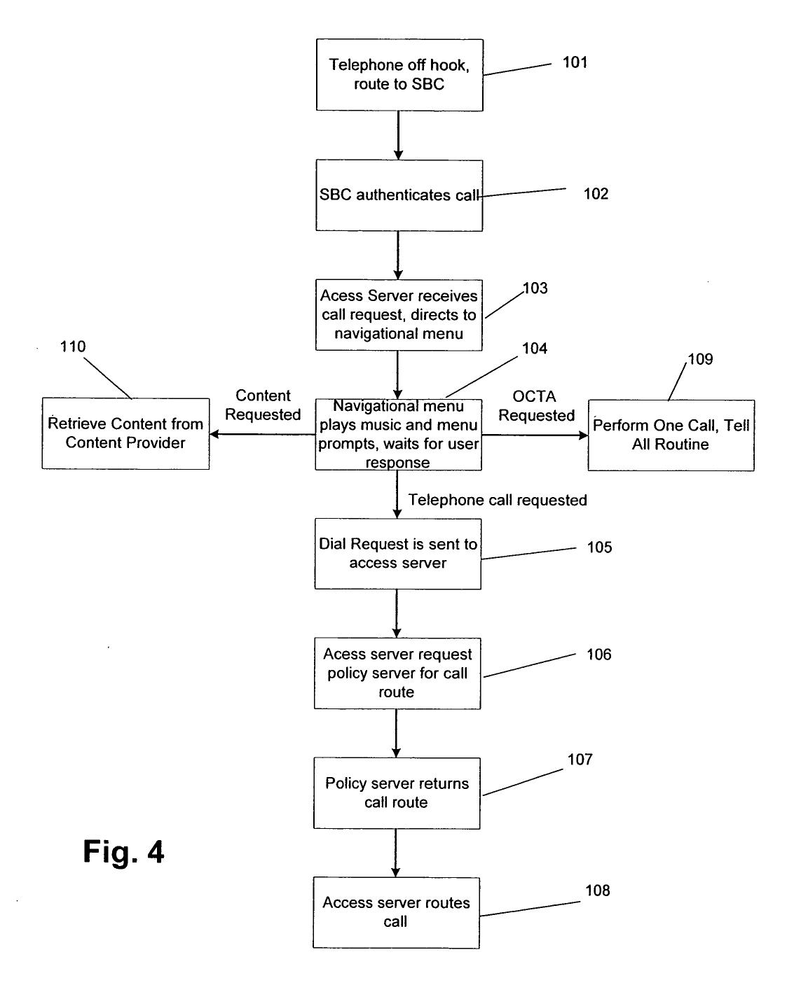

FIG. 4 is a flow diagram of the functionality performed by network operations center 25 when an outbound call is made by a user at telephone 12, or when a user requests other communication services.

101: Telephone 12 goes off hook and routes call through ATA 14 and the Internet 20 to SBC 32.

102: SBC 32 authenticates the call, making sure the call is from a paying or legitimate subscriber.

103: Access server 34 receives the call request from SBC 32 and directs it to the navigational menu of speech recognizer 30.

104: The navigational menu plays music or other audio material, and then plays menu prompts and waits for a user response in the form of voice commands or DTMF input. When a user desires to make an outbound call, the user will respond with a telephone number. If the user desires content, the user will respond with the type of content desired (e.g., weather, stocks, horoscope, etc.) and the content will be retrieved from the content provider at 110. More details on how the content is retrieved is disclosed below. If the user wants to send a message in a “one call, tell all” routine (disclosed in more detail below), the user will request “one call, tell all” and the one call, tell all routine will be executed at 109.

105: Based on the user's response, a request is sent to access server 34 to route accordingly.

106: Access server 34 requests policy server 36 for a call route.

107: Policy server 36 returns the call route.

108: Access server 34 routes the call.

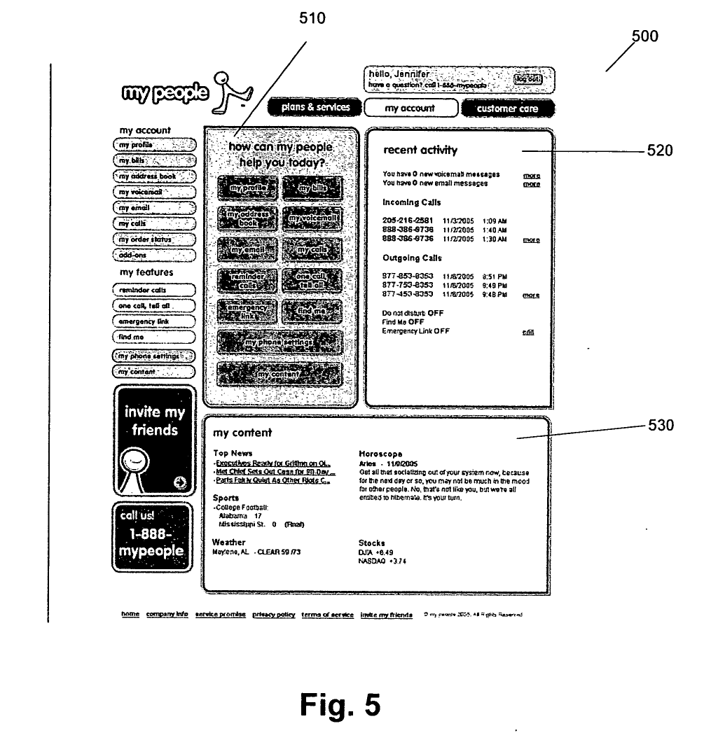

FIG. 5 illustrates a graphical user interface 500 in accordance with one embodiment of the present invention. In one embodiment, interface 500 is displayed at computer 16. Interface 500 includes a menu 510 which allows a user to select a page for updating or inserting data. Interface 500 further includes a recent activity section 520 that displays the current number of voicemail and e-mail messages, a listing of incoming and outgoing calls, and on/off status of various functions. Interface 500 further includes a “my content” section 530 that displays content of interest to the user.

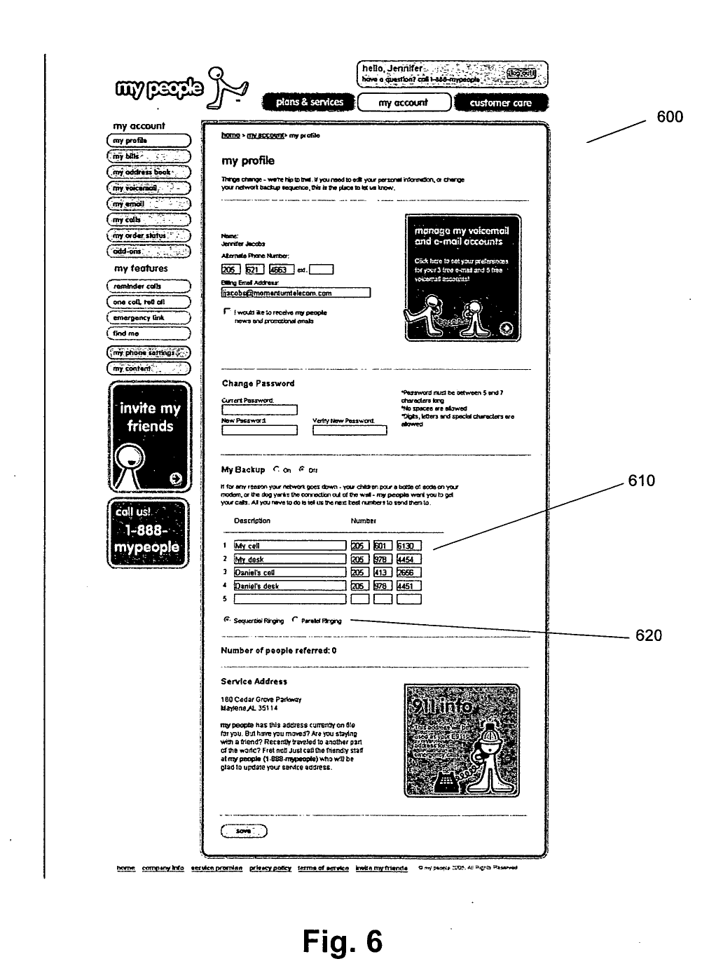

FIG. 6 illustrates a graphical user interface 600 in accordance with one embodiment of the present invention. In one embodiment, interface 600 is displayed at computer 16. Interface 600 includes a “my backup” section 610 in which a user can enter a list of alternate telephone numbers that telephone calls will be routed to if the network is out of service. At 620, the user can choose for all of the telephone numbers to be ringed sequentially or in parallel.

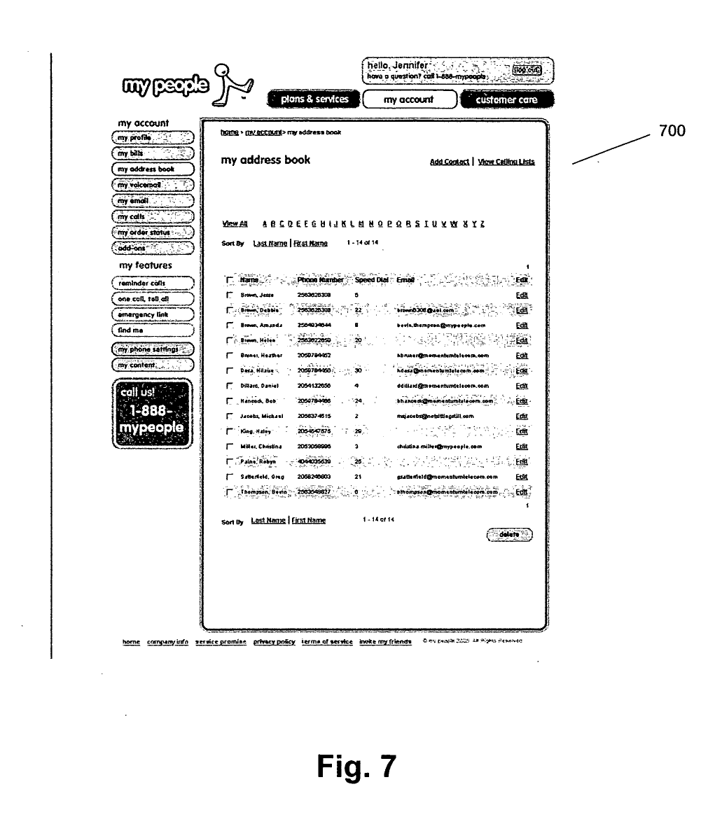

FIG. 7 illustrates a graphical user interface 700 in accordance with one embodiment of the present invention. In one embodiment, interface 700 is displayed at computer 16. Interface 700 is an address book for storing names and telephone numbers and corresponding speed dial numbers. A user, via telephone 12, can dial the numbers stored in interface 700 by verbally speaking the name or speed dial, which is recognized by speech recognizer 30 and which has access to interface 700 to limit the choices that need to be recognized.

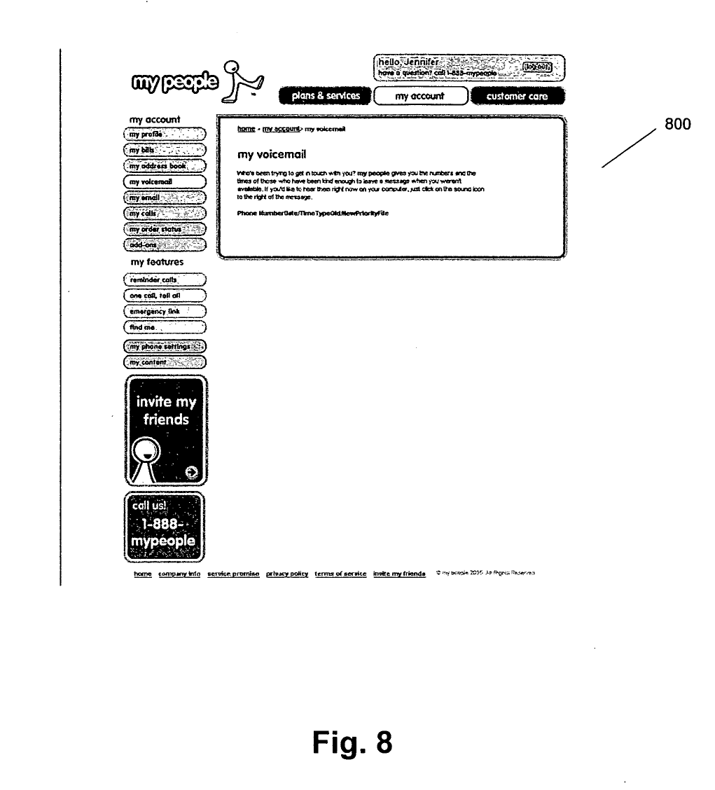

FIG. 8 illustrates a graphical user interface 800 in accordance with one embodiment of the present invention. In one embodiment, interface 800 is displayed at computer 16. Interface 800 allows a user to click on a voice mail message, and listen to that message at computer 16, rather than having to listen to voice messages at telephone 12.

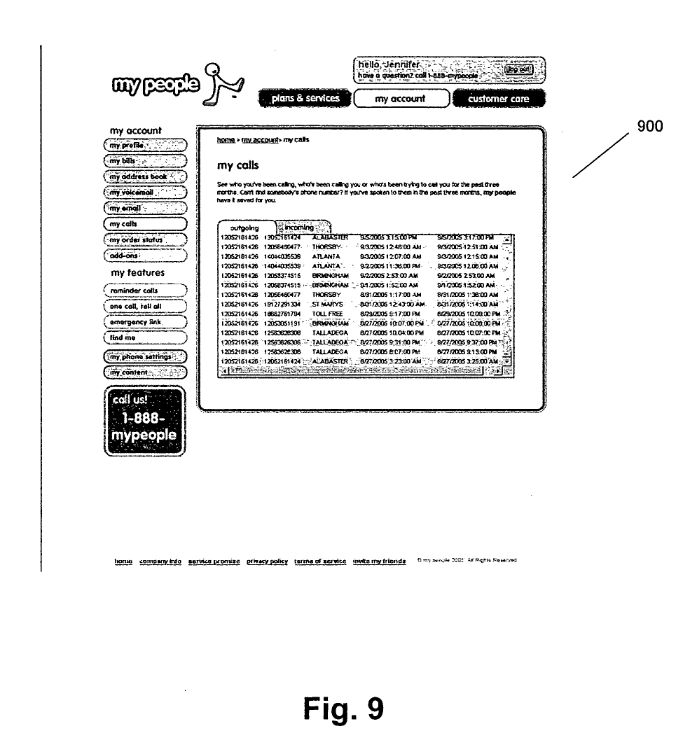

FIG. 9 illustrates a graphical user interface 900 in accordance with one embodiment of the present invention. In one embodiment, interface 900 is displayed at computer 16. Interface 900 provides a list of all outgoing calls and incoming calls.

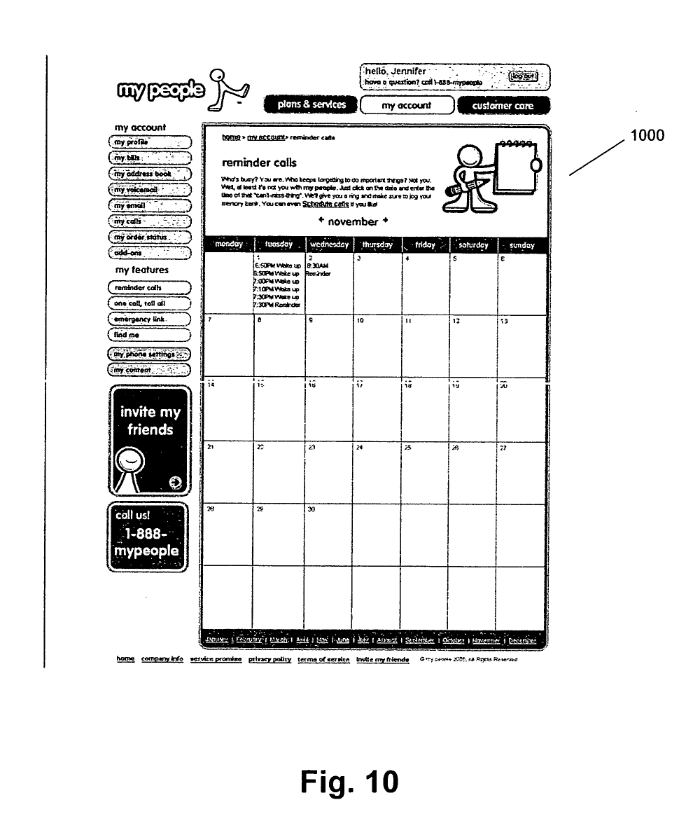

FIG. 10 illustrates a graphical user interface 1000 in accordance with one embodiment of the present invention. In one embodiment, interface 1000 is displayed at computer 16. Interface 1000 is a calendar in which a user can enter desired reminder calls. Reminder calls can be wake up calls, or other calls such as a reminder of a birthday. When the entered date and time arrives, network operations center 25 automatically generates a call to telephone 12, and uses test-to-speech to inform the user of the desired information.

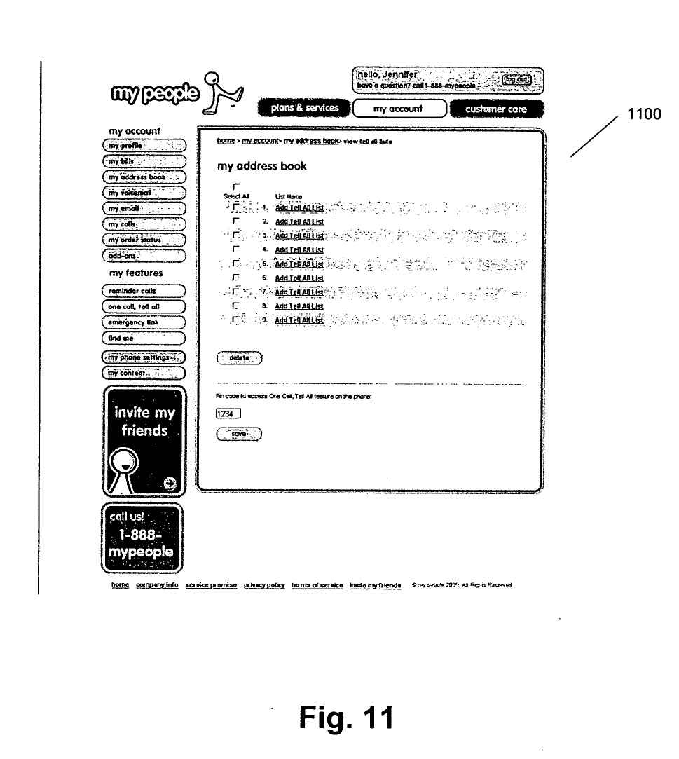

FIG. 11 illustrates a graphical user interface 1100 in accordance with one embodiment of the present invention. In one embodiment, interface 1100 is displayed at computer 16. Interface 1100 displays a list of “one call, tell all” lists. Each one call, tell all list is a grouping of telephone numbers under a designated name. For example, a “soccer team” list will store all telephone numbers of everyone on a soccer team. A user at telephone 12 can then say “one call, tell all” when connected to speech recognizer 30. The navigational menu will ask as input the name of the one call, tell all list and ask for the user to leave a message. Network operations center 25 will then call all telephone numbers on the list and play the identical message to the respective callees. Interface 1100 includes a PIN number to provide security for the one call, tell all list.

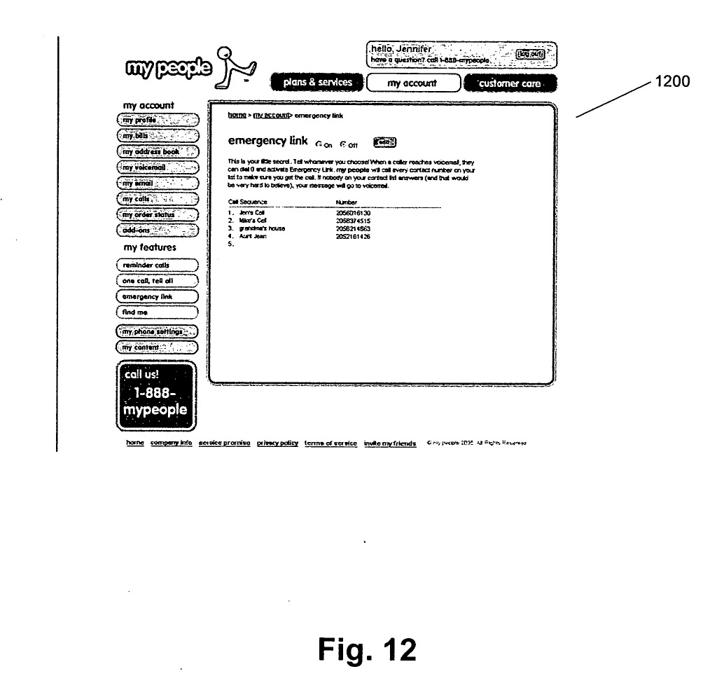

FIG. 12 illustrates a graphical user interface 1200 in accordance with one embodiment of the present invention. In one embodiment, interface 1200 is displayed at computer 16. Interface 1200 is an emergency link page that allows a user to enter a list of emergency contacts and corresponding telephone number. To activate the emergency link, a caller calls a user's telephone number. When the caller reaches voicemail, the caller can dial “0” (or some other agreed upon entry). Network operations center 25 then dials, either sequentially or in parallel, all numbers listed on interface 1200 and connect the caller to whomever answers.

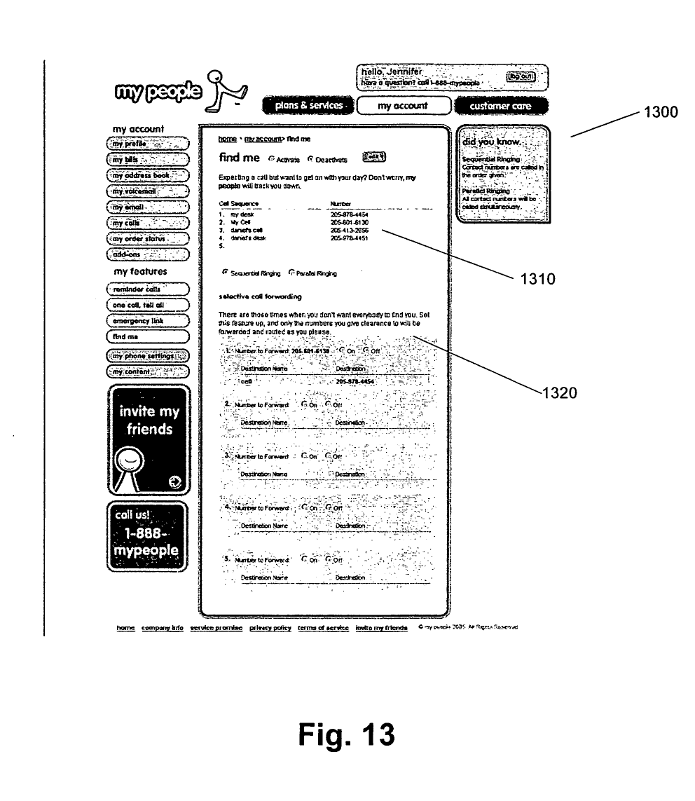

FIG. 13 illustrates a graphical user interface 1300 in accordance with one embodiment of the present invention. In one embodiment, interface 1300 is displayed at computer 16. Interface 1300 includes a “find me” menu 1310 in which the user enters a list of telephone numbers for which a call to the user will be forwarded to if the user is not available at the primary number. The telephone numbers can be dialed sequentially or in parallel. Interface 1300 further includes a call forwarding menu 1320 that allows a user to select specific times where only designated callers will be routed to the user.

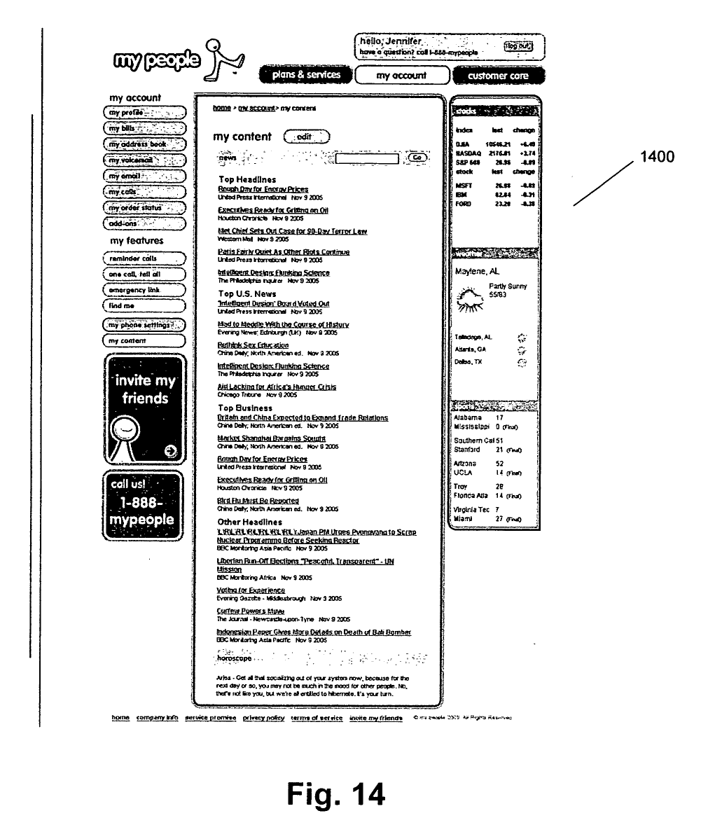

FIG. 14 illustrates a graphical user interface 1400 in accordance with one embodiment of the present invention. In one embodiment, interface 1400 is displayed at computer 16. Interface 1400 is a content page that displays the user's desired content. Not shown is an option for the user to enter desired content. For stocks, the user will enter a list of stock symbols. For weather, the user will enter a list of locations for desired weather. For horoscope, the user will enter a list of birthdates.

In one embodiment, network operations center 25 stores content at a predetermined time interval (e.g., every 20 minutes) from a content provider. Therefore, when content is retrieved at 110 of FIG. 4, the content will be readily available without undue delay. The content available to the user is based on the desired content entered at interface 1400. For example, for sports content a user will enter a list of sports teams (e.g., Pittsburgh Steelers, Florida Gators) or city names (e.g., Pittsburgh, New York) that the user is interested in. Then, at 104 of FIG. 4, when the user says “sports”, all stored content for those sports teams or selected city teams will be read to the user at telephone 12. Similarly, for stocks, when the user says “stock”, all quotes and news for the stocks stored by the user at interface 1400 will be read to the user at telephone 12. For horoscopes, all horoscopes for the date or dates stored by the user at interface 1400 will be read to the user at telephone 12. In other embodiments, the content can be retrieved from the Internet 20 when requested.

As disclosed, the computer telephony system of the present invention automatically connects a user to a voice recognition system when the user's telephone goes off hook. The user can then easily initiate a telephone call or obtain other telecommunication services through simple voice commands or DTMF entry.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of interfacing with a user of a telephone, comprising:
detecting an off-hook at the telephone;
coupling the telephone to a speech recognition system; and
receiving an input to the speech recognition system.

2. The method of claim 1, wherein the input is a voice command.

3. The method of claim 1, wherein the input is a Dual Tone Multi-Frequency input.

4. The method of claim 1, further comprising:
providing an initial audio message to the user.

5. The method of claim 4, wherein the audio message is not a dial tone.

6. The method of claim 1, wherein the telephone is coupled to the speech recognition system without any action by the user.

7. The method of claim 1, further comprising coupling the user to a callee via a public switched telephone network in response to the input.

8. The method of claim 1, further comprising presenting audio content to the user in response to the input.

9. The method of claim 1, further comprising dialing a plurality of callees and playing a message for each of the callees in response to the input.

10. The method of claim 1, wherein the telephone is automatically coupled to the speech recognition system via an Internet.

11. A telephony system comprising:
a speech recognition system;
a processor;
a memory device coupled to said processor, said memory storing instructions which, when executed by said processor cause said processor to:
detect an off-hook at a telephone;
couple the telephone to the speech recognition system; and
receive an input to the speech recognition system from a user of the telephone.

12. The telephony system of claim 11, wherein the input is a voice command.

13. The telephony system of claim 11, wherein the input is a Dual Tone Multi-Frequency input.

14. The telephony system of claim 11, said instructions further causing said processor to:
provide an initial audio message to the user.

15. The telephony system of claim 14, wherein the audio message is not a dial tone.

16. The telephony system of claim 11, wherein the telephone is coupled to the speech recognition system without any action by the user.

17. The telephony system of claim 11, said instructions further causing said processor to couple the user to a callee via a public switched telephone network in response to the input.

18. The telephony system of claim 11, said instructions further causing said processor to present audio content to the user in response to the input.

19. The telephony system of claim 11, said instructions further causing said processor to dial a plurality of callees and playing a message for each of the callees in response to the input.

20. The telephony system of claim 11, wherein the telephone is automatically coupled to the speech recognition system via an Internet.
